(19) United States
(12) Patent Application Publication
(10) Pub. No.: US 2013/0318181 A1
(43) Pub. Date: Nov. 28, 2013

(54) EMAIL PROCESSING SYSTEM AND EMAIL PROCESSING METHOD

(71) Applicant: SEIKO EPSON CORPORATION, Tokyo (JP)

(72) Inventors: Shoichi NAKAJO, Matsumoto (JP); Raigo MIYAZAWA, Matsumoto (JP)

(73) Assignee: SEIKO EPSON CORPORATION, Tokyo (JP)

(21) Appl. No.: 13/897,884

(22) Filed: May 20, 2013

(30) Foreign Application Priority Data
May 24, 2012 (JP) 2012-118315

(51) Int. Cl. H04L 12/58

(52) U.S. Cl. CPC H04L 51/08
USPC 709/206

(57) ABSTRACT

To execute data processing without waste in a plurality of devices, on the basis of a multi-address transmitted email, in a cloud computing system for processing an email, an email processing system is provided with: a communication unit for receiving an email sent to a pre-established address; a determination unit for determining whether the received email is a first class of email for providing notification of a first state where some sort of action is needed regarding a predetermined data process with respect to a separate email or a second class of email for providing notification of a second state where no action is needed regarding the predetermined data process corresponding to the separate email; and a processing unit for executing the predetermined data process based on an email determined to be the first class of email, but not executing the predetermined data process based on the determined result by the determination unit.

### CROSS-REFERENCE TO RELATED APPLICATIONS

This application claims priority to Japanese Patent Application No. 2012-118315 filed on May 24, 2012. The entire disclosure of Japanese Patent Application No. 2012-118315 is hereby incorporated herein by reference.

### BACKGROUND

1. Technical Field

The present invention relates to an email processing system and an email processing method; in particular, the invention relates to a cloud computing system for making it possible to send an email to a specific email address and thereby print the body or an attached file of the email.

2. Background Technology

A cloud computing system provided with a function for receiving an email and then printing the body or an attached file of the email has been known (for example, Patent Document 1). The cloud computing system (hereinafter simply “print system”) is provided with a server for receiving a specific email and thereupon generating print data corresponding to a specific printer on the basis of a body or an attached file of the email, and a printer for acquiring the print data from the server and executing printing. As such, a user of the print system is enabled to use a printer that is registered in the print system even in a case where a printer driver has not been installed in a client terminal, such as a personal computer (PC) or smartphone. In the print system, when a process for registering a printer, including allocating to the printer an email address for receiving something that is to be printed, has been done in a server, then any user who knows the email address will be able to use the printer. Such a print system is similar to a facsimile in that sent information is printed at a destination. In fact, it would also be possible to send an email with an attached image to such a print system from a multifunction peripheral able to send a read image in an email, as has become increasingly widespread in recent years. Further, it would also be possible to register such a multifunction peripheral as a printer in the print system.

Japanese Laid-open Patent Publication No. 2008-71257 (Patent Document 1) is an example of the related art.

### SUMMARY

### Problems to Be Solved by the Invention

In the print system described above, it is desirable to provide notification of the completion of printing or of an error to a request origin having requested printing by email. In view whereof, it would be assumed in the print system described above that the print system would, on behalf of the printer, provide to the request origin an email notification of the print status with respect to the email of the print request. In a case herein where the request origin is a multifunction peripheral provided with a function for reading an image, a function for sending a read image by email, and a print function, and has been registered in the print system as a printer, then an email providing notification of the status of printing for an email with a read image attached is sent by the print system, received by the print system, and, as a result, printed by the multifunction peripheral, which is the request origin. However, when the print system in this manner provides notification of the status of printing by the multifunction peripheral, too, to the printer of the request destination, then the status of printing by the multifunction peripheral of the request origin will be printed by the printer of the request destination, and such status notifications and printing will be continued in alternation indefinitely.

One advantage of the invention is to execute data processing without waste in an email processing system for accepting data processing by email.

### Means Used to Solve the Above-Mentioned Problems

(1) An email processing system for achieving the foregoing advantage is provided with: a communication unit for receiving an email sent to a pre-established address; a determination unit for determining whether the received email is a first class of email for providing notification of a first state where some sort of action is needed regarding a predetermined data process with respect to a separate email or a second class of email for providing notification of a second state where no action is needed regarding the predetermined data process corresponding to the separate email; and a processing unit for executing the predetermined data process based on an email determined to be the first class of email, but not executing the predetermined data process based on an email determined to be the second class of email. According to the invention, the execution of wasteful data processing can be prevented, because the question of whether or not the predetermined data process corresponding to a received email is to be executed is determined depending on the type of that email.

(2) The email processing system for achieving the foregoing advantage can be further provided with a mail generation unit for generating either the first class of email or the second class of email, in accordance with the status of the predetermined data process, there being included identification information indicative of the status of the predetermined data process and a transmission destination being a transmission origin of the received email; wherein the communication unit sends the first class of email and the second class of email generated by the mail generation unit. Adopting this configuration makes it possible to provide to a request origin a notification of the status of the data process corresponding to the received email.

(3) In the email processing system for achieving the foregoing advantage, the mail generation unit can not generate the first class of email and the second class of email in response to an email determined to be either the first class of email or the second class of email. Adopting this configuration makes it possible to prevent wasteful sending and receiving of emails, because an email for providing notification of the status of the corresponding data process is not sent in response to an email providing notification of the status of the data process.

(4) In the email processing system for achieving the foregoing advantage, the processing unit can execute the predetermined data process based on an email determined not to be the first class of email and the second class of email. Adopting this configuration causes the data process to be executed in response to an email that is not an email for providing notification of the status of the data process to the request origin.

(5) In the email processing system for achieving the foregoing advantage, the first state can include failure of the predetermined data process, and the second state can include completion of the predetermined data process. Adopting this configuration causes notification of the failure of the data process to be provided to the request origin and prevents notification of the completion of the data process from being provided to the request origin.

(6) In the email processing system for achieving the foregoing advantage, the predetermined data process can be a process for generating print data on the basis of the received email and sending the print data to a printer associated with the address. Adopting this configuration causes notification of the status of printing at the printer corresponding to the email to be provided by email to the transmission origin of the email that is the request origin for printing. Also, in a case where the request origin for printing is a printer that acquires print data from the email processing system and executes printing, then the print status at the printer that is the request destination is printed at the printer of the request origin in accordance with the print status. For example, in a case where printing has failed at the printer of the request destination, it would be possible to provide to the user notification of the failure by printing with the printer of the request origin.

The functions of each of the parts set forth in the claims are implemented by the hardware resources for which the configuration itself identifies a function, by hardware resources for which a program identifies a function, or by a combination thereof. Also, the functions of each of the parts are not limited to each being implemented by one or a plurality of hardware resources that are physically independent of one another, but rather a plurality of functions can be implemented by one hardware resource. The invention is established also as a method, also as a computer program for causing a server and a printer to implement the functions described above, and also as a recording medium for the program. It shall be readily understood that the recording medium for the computer program can be a magnetic recording medium, a magneto-optical recording medium, or some recording medium that is developed in the future.

### BRIEF DESCRIPTION OF THE DRAWINGS

Referring now to the attached drawings which form a part of this original disclosure:

FIG. 1 is a block diagram illustrating an email processing system;

FIG. 2A is a block diagram illustrating a configuration of a server, and FIG. 2B is a block diagram illustrating a configuration of a multifunction peripheral;

FIG. 3 is a sequence diagram illustrating a setup sequence;

FIG. 4 is a sequence diagram illustrating a login sequence;

FIG. 5 is a sequence diagram illustrating a print sequence;

FIG. 6 is a flow chart illustrating a procedure for determining whether or not printing is needed;

FIG. 7 is a flow chart illustrating a procedure for determining whether or not notification of a status of acceptance of a print request is needed;

FIG. 8 is a flow chart illustrating a procedure for determining whether or not notification of a print execution result is needed; and

FIG. 9 is a sequence diagram illustrating a print sequence.

### DETAILED DESCRIPTION OF EXEMPLARY EMBODIMENTS

The following describes modes for carrying out the invention, with reference to the accompanying drawings. Constituent elements that correspond to each other in each of the drawings have been assigned like reference numerals, and duplicate descriptions thereof have been omitted.

### 1. Configuration

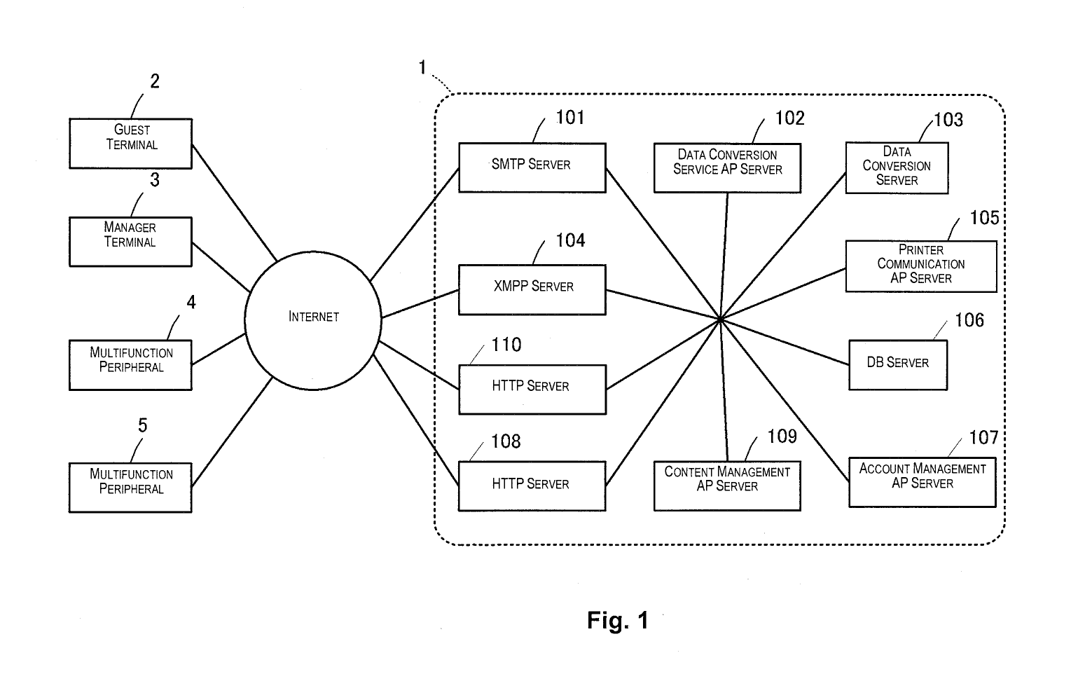

FIG. 1 is a block diagram illustrating a print system serving as one embodiment of the invention. The print system is configured to be a cloud computing system making it possible for an email to be sent to an email address associated with registered multifunction peripherals 4, 5 and for a body and an attachment file of the email to thereby be printed, and is constituted of an email processing system 1 and a plurality of multifunction peripherals 4, 5.

The email processing system 1 is constituted of a simple mail transfer protocol (SMTP) server 101, a data conversion service application (AP) server 102, a data conversion server 103, an extensible messaging and presence protocol (XMPP) server 104, a printer communication AP server 105, a database (DB) server 106, an account management AP server 107, a hypertext transfer protocol (HTTP) server 108, a content management AP server 107, and an HTTP server 110.

The SMTP server 101, which serves as a communication unit, is a server that has a function for sending and receiving an email within an email address unique to the email processing system 1 and email addresses allocated to the registered multifunction peripherals 4, 5.

The data conversion service AP server 102, which serves as a determination unit, is an application server that has a function for determining whether an email received by the SMTP server 101 is an email intended to be printed or is a specific email not intended to be printed, extracting a body and an attached file from an email intended to be printed, and delivering the attachment file and a text file of the body to the data conversion server 103 as something to be printed. The data conversion service AP server 102 also functions as a mail generation unit, and generates and sends over the SMTP server 101 an email for replying to an email to be printed with the print status or the like.

The data conversion server 103, which serves as a processing unit, is a server that has a function for converting to print data the file acquired as being intended to be printed from the data conversion AP server 102. The DB server 106, which serves as a processing unit, is a database server for managing a variety of forms of information for the multifunction peripherals 4, 5 and for storing print data.

The XMPP server 104, which serves as a processing unit, is a server that has a function for communicating with the multifunction peripherals 4, 5 by using XMPP. The printer communication AP server 105, which serves as a processing unit, is an application server for relaying between the XMPP server 104 and the other servers.

The account management AP server 107 is an application server for relaying between the HTTP server 110 and the other servers. The HTTP server 110 is a server that has a function for communicating with a guest terminal 2 and a manager terminal 3 by using HTTP.

The content management AP server 107, which serves as a processing unit, is an application server for relaying between the HTTP server 108 and the other servers. The HTTP server 108, which serves as a processing unit, is a server that has a function for communicating with the multifunction peripherals 4, 5 by using HTTP.

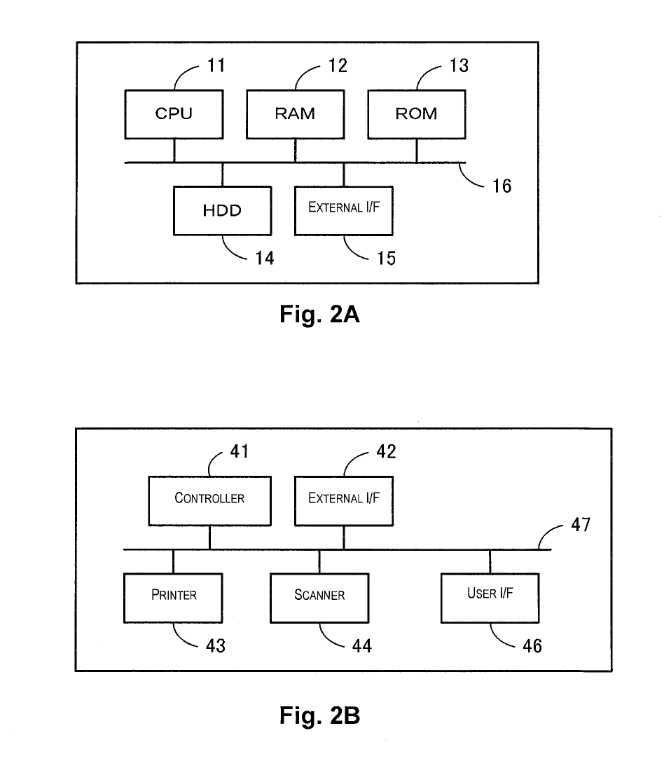

The SMTP server 101, the data conversion service AP server 102, the data conversion server 103, the XMPP server 104, the printer communication AP server 105, the DB server 106, the account management AP server 107, the HTTP server 108, the content management AP server 107, and the HTTP server 110 are each provided with a CPU 11, a RAM 12, a ROM 13, a hard disk device (HDD) 14, an external interface (I/F) 15, and an internal interface (I/F) 16 for connecting same together, as illustrated in FIG. 2A. The ROM 13 stores a startup program. The HDD 14 stores a computer program for implementing each of the various functions described above as well as an operating system (OS). These programs are loaded onto the RAM 12 and executed by the CPU 11. The external I/F 15 is constituted of: an interface for connecting with the other servers, the multifunction peripherals 4, 5, the guest terminal 2, the manager terminal 3, and the like via the Internet; an interface for connecting to a peripheral device; and the like.

Each of the multifunction peripherals 4, 5 is provided with a controller 41, an external I/F 42, a user I/F 46, a printer 43, a scanner 44, and an internal I/F 47 for connecting same together, as illustrated in FIG. 2B. The controller 41 includes a CPU, non-volatile memory, RAM, ASIC, and the like, and executes a process for controlling the operation of the printer 43 by executing a print program stored in the non-volatile memory. The controller 41 communicates with the manager terminal 3 and the email processing system 1 by executing a web service program stored in the non-volatile memory to execute a process for registering the multifunction peripherals 4, 5 in the email processing system 1, for acquiring print data from the email processing system 1, or for attaching to an email and sending image data read by the scanner 44. The multifunction peripherals 4, 5 send an email by using an email address allocated to the email processing system 1, but are not provided with a function for reading an email, and thus do not receive emails. The printer 43 is provided with an actuator, a sensor, a drive circuit, and a mechanical component for executing printing in an inkjet format, a laser format, or another print format known in the art. The scanner 44 is provided with a linear image sensor, an actuator, a drive circuit, and a mechanical component for optically reading a document in a reading format known in the art. The external I/F 42 includes an interface for connecting to the email processing system 1 and the manager terminal 3 over the Internet. The user I/F 46 is an operation panel constituted of a display, operation keys, and the like.

### 2-1. Setup Sequence

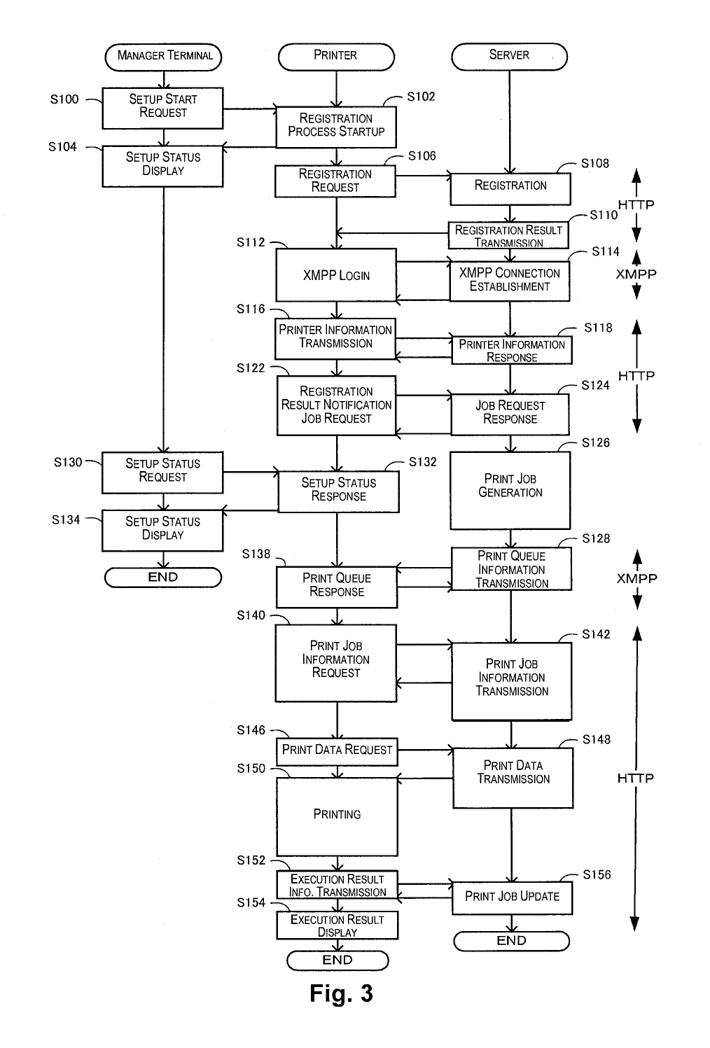

By being registered as printers in the email processing system 1, the multifunction peripherals 4, 5 are incorporated into the print system, enabling the email processing system 1 to execute printing in accordance with an email deemed to be intended to be printed. FIG. 3 is a diagram illustrating a setup sequence for registering the multifunction peripherals 4, 5 in the email processing system 1. The present embodiment describes an example in which an owner of the multifunction peripheral 4 registers the multifunction peripheral 4 in the email processing system 1 by operating the manager terminal 3, which includes a person computer (PC) owned by him.

First, the manager terminal 3, which executes a web browser or the like, communicates with the multifunction peripheral 4 by using HTTP and thereby sends to the multifunction peripheral 4 a setup start request (S100).

Having acquired the setup start request, the multifunction peripheral 4 starts up a registration process, and sends registration status information to the manager terminal 3 by using HTTP (S102).

Having received the registration status information, the manager terminal 3 produces a screen display of the setup status on the basis of the received registration status information (S104).

Having sent the registration status information in accordance with the setup start request, the multifunction peripheral 4 uses HTTP to send to a URL of the HTTP server 108 corresponding to the registration request a model-specific ID of the multifunction peripheral 4, a serial number of the multifunction peripheral 4, and a delete flag for preexisting information, as a registration request corresponding to the multifunction peripheral 4 (S106).

Having acquired the registration request in the HTTP server 108, the email processing system 1 registers the multifunction peripheral 4 in the email processing system 1 as an output device of the print system, on the basis of the registration request (S108). More specifically, having acquired a parameter of the registration request from the HTTP server 108, the account management AP server 107 allocates to the multifunction peripheral 4 an internal ID, XMPP login password, management page URL, management page password, and email address that correspond to the model-specific ID and serial number of the multifunction peripheral 4, while also consulting registration information on other printers already registered in the DB server 106. Allocating the internal ID on the basis of the model-specific ID and serial number of the multifunction peripheral 4 makes it possible to reliably allocate to the multifunction peripheral 4 a different internal ID for every individual printer, even in a case where the serial number was assigned to the printer in a different system for every model. The management page is a web page for using HTTP to compile these items of information, which are stored in the DB server 106.

The account management AP server 107 stores the XMPP login password, the management page URL, the management page password, and the email address in the DB server 106 as registration information of the multifunction peripheral 4, in association with the internal ID corresponding to the model-specific ID and serial number of the multifunction peripheral 4.

The account management AP server 107 registers in the SMTP server 101 the email address allocated to the multifunction peripheral 4. Registering in the SMTP server 101 the email address allocated to the multifunction peripheral 4 makes it possible for the email processing system 1 to receive an email, serving as a print request, that has the multifunction peripheral 4 as the output device.

The account management AP server 107 associates together the XMPP login password and the internal ID allocated to the multifunction peripheral 4, and registers same in the XMPP server 104. An XMPP JID for the XMPP server 101 to communicate with the multifunction peripheral 4 by using XMPP is “internal ID” @ “an XMPP domain name of the XMPP server 104”. Registering the XMPP login password and the internal ID of the multifunction peripheral 4 as XMPP connection information in the XMPP server 104 makes it possible for the multifunction peripheral 4 and the email processing system 1 to communicate with each other by using XMPP.

Having registered the multifunction peripheral 4 in the email processing system 1 as an output device of the print system, the account management AP server 107 sends registration result information for the multifunction peripheral 4 to the multifunction peripheral 4, which is the transmission origin of the registration request, over the HTTP server 108 (S110). The registration result information includes the internal ID, XMPP login password, management page URL, management page password, email address, and XMPP server 104 domain name allocated to the multifunction peripheral 4, as well as the outcome (success/failure) of the receipt of the registration request. In a case where a plurality of XMPP servers are provided to the email processing system 1 for the purpose of load sharing, then the multifunction peripheral 4 must be notified of the domain name of the XMPP server allocated to the multifunction peripheral 4, but in a case where all printers registered in the email processing system 1 communicate by a shared XMPP server, then the multifunction peripheral 4 need not necessarily be notified of the domain name of the XMPP server.

Having acquired the registration result information from the HTTP server 108, the multifunction peripheral 4 stores in the non-volatile memory the internal ID, the XMPP login password, the management page URL, the management page password, the email address, and the XMPP server 104 domain name allocated to the multifunction peripheral 4, generates an XMPP JID from the internal ID and the XMPP domain name, and sends the XMPP JID and the XMPP login password to the XMPP server 104 as XMPP connection information (S112).

Having acquired the XMPP JID and the XMPP login password from the multifunction peripheral 4, the XMPP server 104 establishes an XMPP connection with the multifunction peripheral 4 and sends to the multifunction peripheral 4 the XMPP connection result (success/failure) (S114). When the XMPP connection is successful at this time, the XMPP connection between the multifunction peripheral 4 and the XMPP server 104 is sustained until the power source of the multifunction peripheral 4 is shut off.

When an XMPP connection with the email processing system 1 is established, the multifunction peripheral 4 sends printer information to the HTTP server 108 (S116). The printer information includes the internal ID allocated to the multifunction peripheral 4, the communication specifications version, menu type information (region information) on the printer, submenu type information (region information) on the printer, and language information on the printer, and is sent by using HTTP to the URL of the HTTP server 108 corresponding to the printer information.

When the printer information is received by the HTTP server 108 from the multifunction peripheral 4, the content management AP server 107 stores the printer information in the DB server 106 in association with the internal ID, and also sends the receipt result (success/failure) to the multifunction peripheral 4 that is the transmission origin (S118). The printer information of the multifunction peripheral 4 is stored in the DB server 106 until the XMPP connection with the multifunction peripheral 4 is ended.

Having received the receipt result (success) of the printer information, the multifunction peripheral 4 sends to the HTTP server 108 a registration result notification job creation request (S122). A registration result notification job is a print job for printing at the multifunction peripheral 4 the content of registering the multifunction peripheral 4 in the email processing system 1. More specifically, the internal ID is sent to the URL of the HTTP server 108 associated with the registration result notification job creation request, as the registration result notification job creation request.

Having received the registration result notification job creation request, the HTTP server 108 sends the receipt result (success/failure) to the multifunction peripheral 4 that is the transmission origin (S124).

When the receipt result (success) of the registration result notification job creation request is sent from the HTTP server 108, the email processing system 1 generates a registration result notification job for the multifunction peripheral 4 to print a registration report (S126). The following is a more specific description. First, the content management AP server 107 acquires the internal ID of the multifunction peripheral 4 from the registration result notification job creation request; acquires from the DB server 106 information of which the user of the manager terminal 3 should be notified, such as the management page URL, the management page password, and the email address stored in association with the acquired internal ID, as well as the model-specific ID of the multifunction peripheral 4 stored in association with the internal ID; and delivers same to the printer communication AP server 105. Next, the printer communication AP server 105 requests in association with a job ID and model ID that the data conversion service AP server 102 generate print data for printing the information of which the user of the manager terminal 3 should be notified, as the registration report. Having received the request, the data conversion service AP server 102 causes the data conversion server 103 to generate print data corresponding to the model-specific ID. Next, the printer communication AP server 105 acquires the print data from the data conversion server 103 and stores same in the DB server 106 as a print job of the multifunction peripheral 4, in association with the internal ID and the job ID.

Having generated the registration result notification job, the email processing system 1 uses XMPP to provide notification of the generation of a new print job to the multifunction peripheral 4, which is the transmission origin of the registration request (S128). More specifically, the printer communication AP server 105 provides, to the multifunction peripheral 4 over the XMPP server 104, print queue information indicative of the fact that a new print job of the multifunction peripheral 4 has occurred. At this time, the XMPP server 104 identifies an XMPP communication partner for the multifunction peripheral 4, on the basis of the internal ID acquired from the printer communication AP server 105, and sends the print queue information to the multifunction peripheral 4 by using XMPP.

Having acquired the print queue information, the multifunction peripheral 4 sends the receipt result (success/failure) to the XMPP server 104 by using XMPP (S138).

Next, the multifunction peripheral 4 sends a request to the email processing system 1 for print job information needed to acquire the print data (S140). More specifically, the multifunction peripheral 4 uses HTTP to send the internal ID of the multifunction peripheral 4 to the URL of the HTTP server 108 corresponding to the request for print job information.

Having received the request for print job information, the email processing system 1 sends to the multifunction peripheral 4 the receipt result (success/failure), the job ID, the URL of the HTTP server 108 corresponding to the job ID, and the type of page-description language of the print data, as the print job information (S142). More specifically, the content management AP server 107 acquires the internal ID acquired by the HTTP server 108 as the request for print job information, and acquires from the DB server 106 the job ID and print data stored in association with the internal ID as well as the page-description language of the print data, and delivers same to the HTTP server 108. The HTTP server 108 generates a URL for accepting an acquisition request for print data corresponding to the job ID, and sends the receipt result (success/failure), the job ID, the URL for accepting the acquisition request for print data, and the type of page-description language for the print data to the multifunction peripheral 4 as the print job information, by using HTTP.

Having acquired the print job information, the multifunction peripheral 4 waits for the multifunction peripheral 4 to reach an idle state and, upon reaching an idle state, requests print data (S 146). More specifically, the printer sends the internal ID of the multifunction peripheral 4 over HTTP as an acquisition request for print data to the URL of the HTTP server 108 for accepting the acquisition request for the print data.

Having received the request for print data, the email processing system 1 uses HTTP to send to the multifunction peripheral 4 the receipt result (success/failure) as well as the requested print data (S148). More specifically, the HTTP server 108 uses HTTP to send to the multifunction peripheral 4 the receipt result as well as the print data corresponding to the URL at which the request for print data was accepted.

Having acquired the print data, the multifunction peripheral 4 executes printing of the registration report on the basis of the print data (S 150).

Having ended printing, the multifunction peripheral 4 sends execution result information to the HTTP server 108 (S 154). More specifically, the multifunction peripheral 4 sends to the URL corresponding to the execution result information of the HTTP server 108 the internal ID of the multifunction peripheral 4, the job ID by which printing was executed, the execution result of the print job (success/failure), and the reason for which the execution result happened (normal, paper jam, out of ink, or the like) (S152).

Having acquired the execution result information at the HTTP server 108, the email processing system 1 updates the print job on the basis of the execution result information (S 156). More specifically, the HTTP server 108 sends the receipt result of the execution result information (success/failure) to the multifunction peripheral 4, and the content management AP server 107 deletes the print data corresponding to the job ID from the DB server 106 on the basis of the execution result information received by the HTTP server 108.

During the execution of the setup sequence described above, the manager terminal 3, having sent the setup start request, periodically requests the setup status from the multifunction peripheral 4 (S130). More specifically, a request for the status of setup is sent to the URL of the multifunction peripheral 4 corresponding to the request for the setup status.

Having accepted the request for the setup status, the multifunction peripheral 4 sends registration status information to the manager terminal 3 by using HTTP (S132). The registration status information is the same as the content sent to the manager terminal 3 in S102 by the multifunction peripheral 4 immediately after the setup start request was acquired.

Having received the registration status information, the manager terminal 3 produces a screen display of the registration status on the basis of the received registration status information, similarly with respect to S104 (S134). At the stage where registration of the multifunction peripheral 4 in the email processing system 1 is completed, for example, the management page URL, the management page password, the email address, and the like are displayed on a screen of the manager terminal 3.

### 2-2. Login Sequence

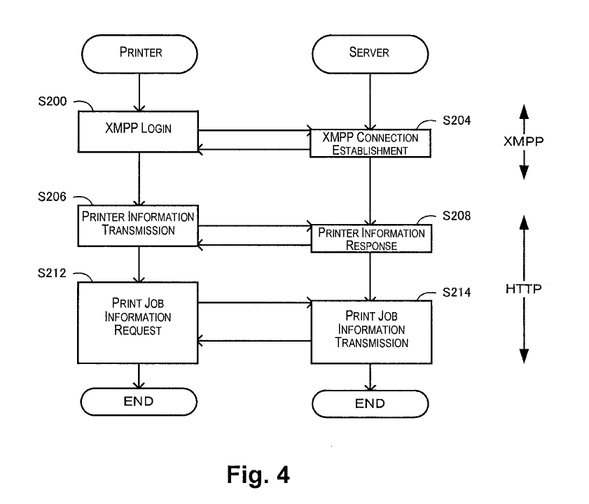

FIG. 4 is a diagram illustrating the login sequence. The login sequence starts when the user, having pressed on a power source button of the multifunction peripheral 4 to shut off the power source after the end of the setup sequence, later presses on the power source button again to turn on the power source. In the login sequence, the multifunction peripheral 4 carries out a process for initializing each of the parts, and also establishes an XMPP connection with the email processing system 1 and carries out a check of the print job.

More specifically, similarly with respect to S112 of the setup sequence, the multifunction peripheral 4 sends the XMPP connection information to the XMPP server 104 (S200). Having acquired the XMPP connection information, the XMPP server 104 establishes an XMPP connection, similarly with respect to S114 (S202).

Having established an XMPP connection with the email processing system 1, the multifunction peripheral 4 uses HTTP to send the printer information to the email processing system 1, similarly with respect to S116 of the setup sequence (S206). That is, the transmission of the printer information is implemented every time the XMPP connection is established with the email processing system 1. Having acquired the printer information, the server uses HTTP to send the receipt result to the multifunction peripheral 4, similarly with respect to S118, and also stores the printer information until the end of the XMPP connection (S208).

Having sent the printer information to the email processing system 1, the multifunction peripheral 4 uses HTTP to send a request for the print job information to the email processing system 1, similarly with respect to S140 of the setup sequence (S212). Having acquired the request for the print job information, the email processing system 1 uses HTTP to send the print job information to the multifunction peripheral 4, similarly with respect to S142 (S214). Having acquired the print job information, the multifunction peripheral 4 requests the print data and executes printing when there is a print job. This manner by which the multifunction peripheral 4 automatically acquires the print job information after the power has been turned on makes it possible, immediately after the power has been turned on, for the multifunction peripheral 4 to execute a print job generated in the email processing system 1 while the power was shut off.

### 2-3. Print Sequence

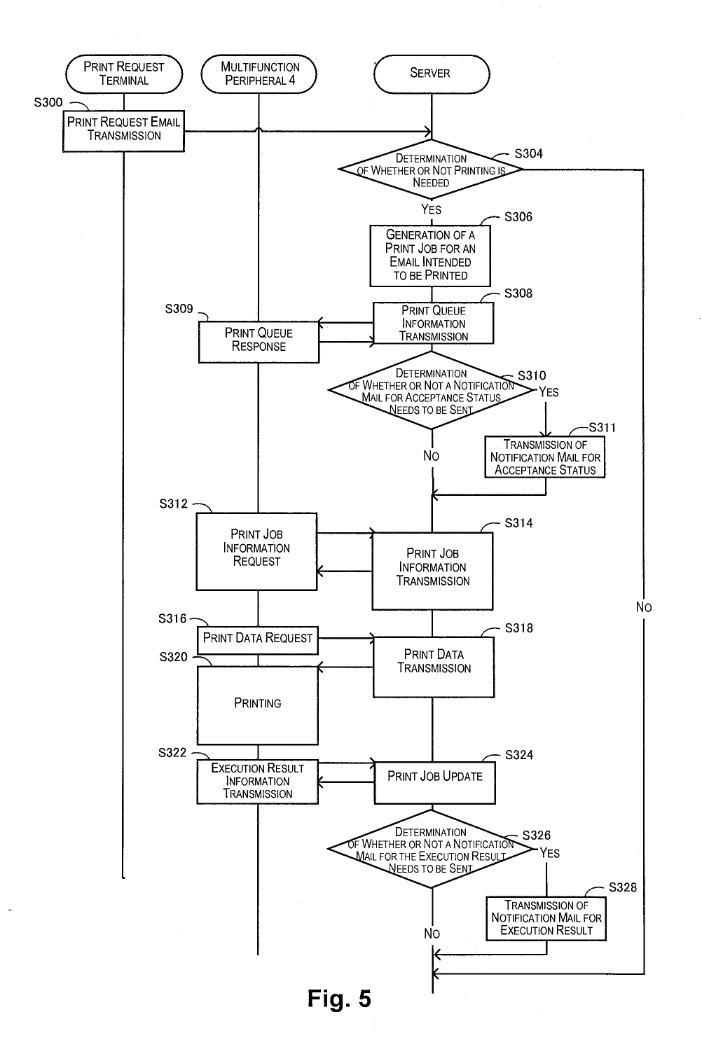

FIG. 5 is a diagram illustrating the print sequence. The print sequence is started by the sending of an email from any terminal to an email address destination allocated to a printer registered in the email processing system 1 (S300). The email processing system 1, as shall be described below, processes the body and attached file(s) of the received email as being intended to be printed. A destination email address of a print request, which is different for every printer, is either displayed on the screen of the manager terminal 3 or printed by a registered printer during the setup sequence, as has already been described. As such, a managing user who has used the manager terminal 3 to register the multifunction peripheral 4 in the email processing system 1 and a guest user who has been provided with notification of the email address by the managing user are both able to use any terminal that is connected to the Internet to send the print request for the multifunction peripheral 4 to the email processing system 1. The following describes when an email serving as a print request is sent to the email address corresponding to the multifunction peripheral 4. The multifunction peripheral 4 is able to send an email by using an email address that is allocated from the email processing system 1 and is included in the registration result information of which notification was provided in S110.

Upon receiving the email, the email processing system 1 analyzes the header and body of the email, and determines whether the received email is an email intended to be printed or is an email not intended to be printed (S304). That is, the question of whether or not printing is needed is determined on the basis of the mail header and body. More specifically, when the STMP server 101 receives the email of the registered email address destination, the data conversion service AP server 102 acquires a “TO”, a “CC”, and a “FROM”, serving as transmission destination information, from the mail header, and also acquires a specific text string of the body or a text string of a range indicated by a symbol. The “TO”, the “CC”, and the “FROM” are listed together with a “BCC” (blind carbon copy) in the header of the email by a mail user agent (MUA) generating the email. In a case where the email is one that was generated by the email processing system 1, then a specific range of the body lists recognition information whereby the class of the email can be identified.

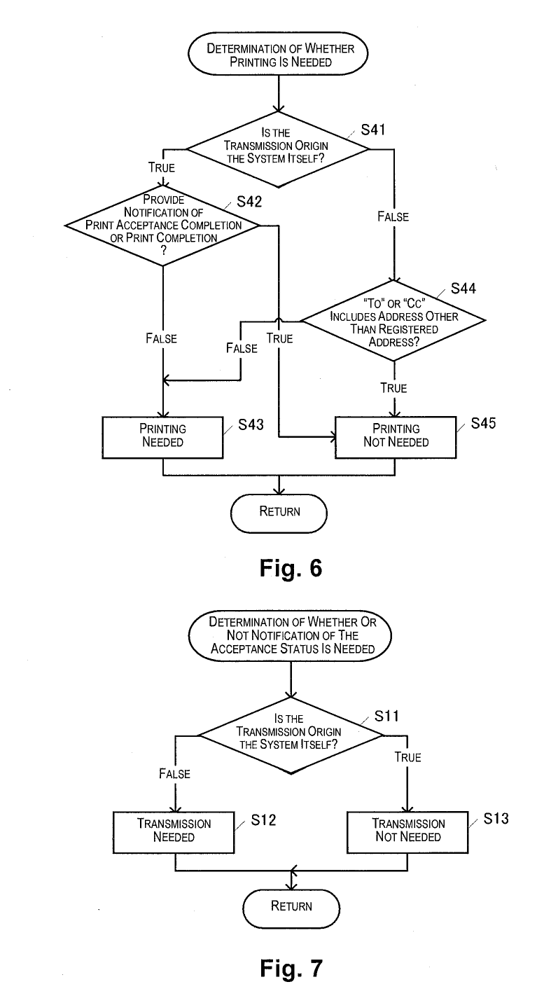

FIG. 6 is a flow chart illustrating a procedure of process for determining whether or not printing is needed. First, the data conversion service AP server 102 determines whether or not the transmission origin of the email is the email processing system 1 itself, on the basis of the “FROM” acquired from the mail header (S41). That the transmission origin of the email received by the email processing system 1 as a print request is the email processing system 1 itself signifies that the email subject to determination is an email for providing notification of the status of data processing by the email processing system 1. More specifically, the transmission origin of the email is determined to be the email processing system 1 itself in a case where an email address specific to the email processing system 1, e.g., the “FROM”, is a pre-established address not predicted to have been allocated to a printer.

In a case where the transmission origin of the email is the email processing system 1, then the data conversion service AP server 102 determines whether or not the email is an email providing notification of the end of print acceptance or the end of printing, on the basis of a text string acquired from a predetermined range of the body in which a start point and an end point are stipulated by a pre-established text string or the like (S42); in a case where the email is not an email providing notification of the end of print acceptance or of the end of printing (a second class of email), i.e., in a case where the email is an email providing notification of a print acceptance failure or a print failure (a first class of email), then the email is understood to be an email intended to be printed (S43), whereas in a case where the email is an email providing notification of the end of print acceptance or of the end of printing, then the email is discarded as an email not intended to be printed (S45).

In a case where the transmission origin of the email is not the email processing system 1 itself, then the data conversion service AP server 102 determines whether or not an address other than the email address allocated to a registered printer is included in the “TO” or “CC” acquired from the header of the email (S44); in a case where no such address is included, then the email is understood to be intended to be printed (S43). In a case where such an address is included, then a determination is made as to whether or not an email address other than an email address allocated to a registered printer is included (S44.1), and in a case where no such address is included, the email is understood to be intended to be printed, and in a case where such an address is included, then the email is discarded as being a specific email not intended to be printed (S45). In a case where an email is received by the SMTP server 101 at an email address allocated to a registered printer, despite an email address allocated to a registered printer not being included in both the “TO” and the “CC”, that email is one where an email address allocated to a registered printer is set to “BCC” during sending. However, in a case where an address other than an email address allocated to a registered printer is set for either the “TO” or “CC” and the email was sent, that email is discarded without being regarded as intended to be printed.

Next, the email processing system 1 generates a print job on the basis of the email determined to be intended to be printed (S306). First, the printer communication AP server 105 understands the body and attached files of the email to be intended to be printed, and allocates an internal ID and job ID to every file. The internal ID is identified from the email address. Next, the printer communication AP server 105 delivers what is intended to be printed to the data conversion server 103, together with the internal ID and job ID, and print data corresponding to the model and print settings is generated on the basis of what is intended to be printed. The printer communication AP server 105 then stores the print data in the DB server 106 as a print job of the multifunction peripheral 4, by association with the job ID and the internal ID of the multifunction peripheral 4.

Next, the email processing system 1 uses XMPP to send the print queue information to the multifunction peripheral 4, which is the request destination for the print execution request (S308). More specifically, the printer communication AP server 105 uses XMPP to provide notification of the print queue information to the multifunction peripheral 4, similarly with respect to S128 of the setup sequence. The email processing system 1 is thus able to autonomously execute the process from when the print request is received until when the print queue information is sent to the multifunction peripheral 4, in order to use XMPP to send the print queue information, and there is no need to poll the multifunction peripheral 4. For this reason, notification of the generation of a print job can be provided immediately to the multifunction peripheral 4, and notification of the generation of print data can be provided to the multifunction peripheral 4 with a minimal amount of communication.

Having acquired the print queue information, the multifunction peripheral 4 uses XMPP to send to the XMPP server 104 the receipt result (success/failure), serving as status information, similarly with respect to S138 of the setup sequence (S309).

Having received the receipt result for the print queue information from the multifunction peripheral 4 via the XMPP server 104, the data conversion service AP server 102 determines whether or not it is necessary to send an email where the body includes recognition information indicative of the status of acceptance of the print request and where the destination is the transmission origin of the print request (the first class of email and the second class of email) (S310).

FIG. 7 is a flow chart illustrating the procedure for determining whether or not it is necessary to send, and sending, an email providing notification of the status of acceptance of the print request. The data conversion service AP server 102 determines whether or not the transmission origin of the email is the email processing system 1 itself, on the basis of the “FROM” acquired from the mail header (S11). In a case where the transmission origin of the email is the email processing system 1 itself, it is understood not to be necessary to send an email indicative of the status of acceptance (S13). An email B sent by the email processing system 1 is an email for providing to the sender of any email A a data processing status, such as acceptance completion, print completion, or print failure, with respect to the email A, whereupon receipt of such an email B by the email processing system 1 itself signifies that the terminal that sent the email A is itself registered as a printer in the email processing system 1. More specifically, the email A is a case where an email has been sent from the multifunction peripheral 5, to which an email address has been allocated from the email processing system 1. That the email B is determined to be intended to be printed means that the email B is of the first class of email, which provides notification of the print acceptance failure or print failure of the email A. When in such a case an email providing notification of the print acceptance failure or print failure of a print request is sent to the request origin, then the email thus sent will be again received by the email processing system 1 as a print request for a printer. In a case where the transmission origin of the email is the email processing system 1 itself, then not sending an email indicative of the status of acceptance of the print request prevents such a chain of useless sending and receiving.

In a case where the transmission origin of the email is not the email processing system 1 itself, the data conversion service AP server 102 regards as unnecessary the sending of an email indicative of the status of acceptance (S 12). In a case where it is determined to be unnecessary to send an email indicative of the status of acceptance, the data conversion service AP server 102 sends an email where the destination is the transmission origin of the print request and where the body includes information by which acceptance success or acceptance failure can be recognized, in accordance with the receipt result of the print queue information (S311). More specifically, in a case where the receipt result for the print queue information is success, then the power source of the multifunction peripheral 4, for which print was requested, will have been turned on, and communication between the email processing system 1 and the multifunction peripheral 4 will have been established. As such, in a case where the receipt result for the print queue information is success, an email providing notification that acceptance of the print request is completed (the second class of email) is sent. In such a case, the recipient of the second class of email need not take any action. In a case where the receipt result for the print queue information is failure, however, then the status is that communication between the email processing system 1 and the multifunction peripheral 4 has not been established, for some reason such as the power source of the multifunction peripheral, for which printing was requested, being turned off. As such, in a case where the receipt result for the print queue information is failure, an email providing notification that acceptance of the print request has failed (the first class of email) is sent. In such a case, the recipient of the first class of email must take some sort of action, such as turning on the power source of the multifunction peripheral 4. Notification of the status of acceptance completion or acceptance failure for the print request is provided by listing a pre-established text string in a specific range in the body of the email. Such a text string includes guide information for a person to understand the status, as well as recognition information for a computer to identify the status. The guide information is information which, when read, allows a person to understand that, for example, “The print request was accepted”. The recognition information is information optimized for recognition processing by a computer, where, for example, “acceptance completion” is “01” and “acceptance failure” is “02”; the range therefor is defined by the specific symbol or text string.

Having sent the receipt result (success) for the print queue information, the multifunction peripheral 4 uses HTTP to send to the email processing system 1 print job information needed in order to acquire the print data, similarly with respect to S140 (S312). More specifically, the multifunction peripheral 4 uses HTTP to send the internal ID of the multifunction peripheral 4 to the URL of the HTTP server 108 corresponding to the request for print job information.

Having received the request for the print job information, the email processing system 1 uses HTTP to send to the multifunction peripheral 4 the receipt result (success/failure), the job ID, the URL of the HTTP server 108 corresponding to the job ID, and the type of page-description language for the print job as the print job information, similarly with respect to S142 (S314).

Having acquired the print job information, the multifunction peripheral 4 waits for the multifunction peripheral 4 to reach an idle state, similarly with respect to S146, and when an idle state is reached, requests that print data be sent by sending to the HTTP server 108 a URL for accepting a request to acquire print data (S316).

Having been requested to send the print job, the HTTP server 108 uses HTTP to send to the multifunction peripheral 4 the print data that corresponds to the URL at which the request to acquire the print data was accepted, along with the receipt result (success/failure), similarly with respect to S148 (S318).

Having acquired the print data, the multifunction peripheral 4 executes printing on the basis of the print data, similarly with respect to S150 (S320).

Having finished printing, the multifunction peripheral 4 sends execution result information on the print job to the HTTP server 108 as status information, similarly with respect to S154 (S322).

Having acquired the execution result information at the HTTP server 108, the email processing system 1 updates the print job on the basis of the execution result information, similarly with respect to S156 (S324).

Next, the email processing system 1 determines whether or not it is necessary to send an email where the destination is the transmission origin of the print request and where the body includes recognition information indicative of the execution result of the print request (completion/failure) (S326).

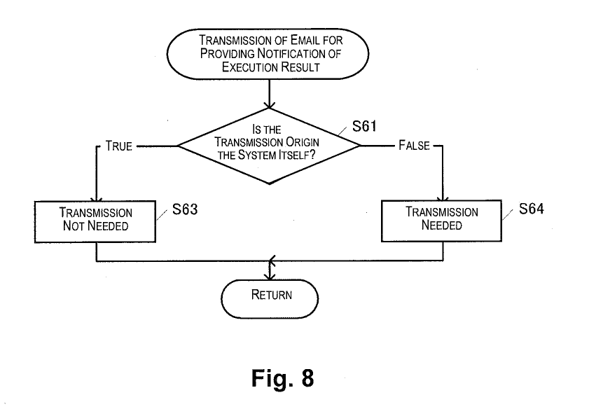

FIG. 8 is a flow chart illustrating the procedure for determining whether or not it is necessary to send an email providing notification of the execution result for the print request. The data conversion service AP server 102 determines whether or not the transmission origin of the email is the email processing system 1 itself, on the basis of the “FROM” acquired from the mail header (S61). In a case where the transmission origin of the email is not the email processing system 1 itself, it is regarded as necessary to send an email providing notification of the execution result for the print request (S64). In a case where the transmission origin of the email is the email processing system itself, it is regarded as unnecessary to send an email providing notification of the execution result for the print request (S63). As already stated, the email B sent by the email processing system 1 is an email for providing to the sender of any email A a data processing status, such as acceptance completion, print completion, or print failure, with respect to the email A, whereupon receipt of such an email B by the email processing system 1 itself signifies that the terminal that sent the email A is itself registered as a printer in the email processing system 1. When in such a case an email indicative of the execution result for the print request is sent to the request origin, then the email thus sent will be again received by the email processing system 1 as a print request for a printer. In a case where the transmission origin of the email is the email processing system 1 itself, then not sending an email indicative of the execution result of the print request prevents such a chain of useless sending and receiving.

In a case where it is determined to be necessary to send an email providing notification of the execution result for the print result, then the data conversion service AP server 102 sends an email where the destination is the transmission origin of the print request and where the body includes recognition information indicative of print completion or print failure, in accordance with the print execution result information (S328). Of the emails sent at this time, an email providing notification of print failure (a first state) requiring that the recipient of the email take some sort of action, such as placing a sheet of paper, corresponds to the first class of email, and an email providing notification of print completion (a second state) not requiring the recipient of the email to take any action corresponds to the second class of email.

With the foregoing, the data processing by the email processing system 1 for the emails of the print request is tentatively concluded. However, in a case where an email for a print request is sent from the multifunction peripheral 5, which was registered in the email processing system 1 as a printer, and either acceptance or printing of the print request has failed, then the processing in S311 or S328 described above is executed, as a result of which an email where the body includes the recognition information indicative of the acceptance failure or print failure (the first class of email) will be received by the email processing system 1 itself as a print request.

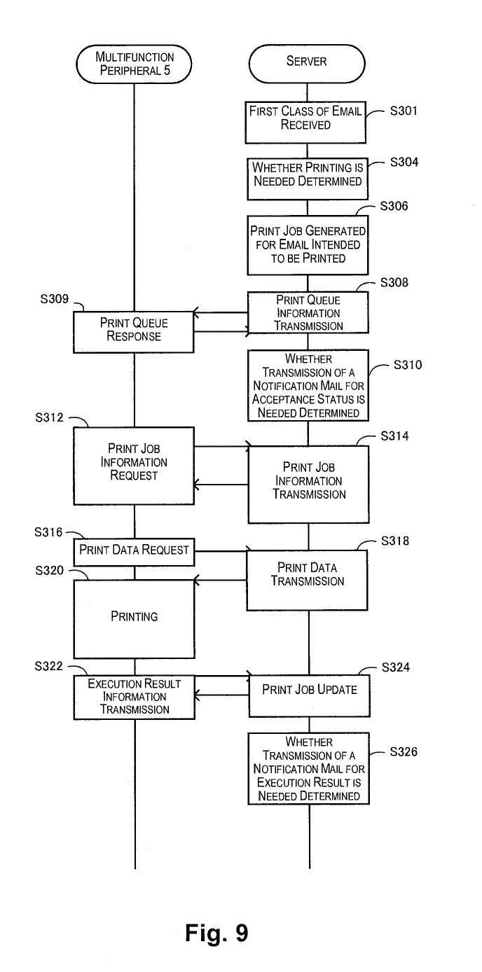

In view whereof, the following describes the operation in a case where the first class of email of such description is received by the email processing system 1 as a print request, with reference to FIG. 9. When an email where the body includes the recognition information indicative of acceptance failure or print failure is received by the email processing system 1 itself as a print request (S301), then the email is determined (S34) to be intended to be printed in the process for determining whether or not printing is required (S304), a print job is generated (S306), and the full body of the email where the body includes the guide information and recognition information indicative of the acceptance failure or print failure is printed by the multifunction peripheral 5 (S320). As a result, the user of the multifunction peripheral 5, having sent the email in order to cause the multifunction peripheral 5 to print, is able to know that printing was not executed by the multifunction peripheral 4.

However, because the transmission origin of the email is the email processing system 1 itself, it will regarded as unnecessary to send an email indicative of the acceptance status in the processing for determining whether or not it is necessary to send an email providing notification of the acceptance status and print execution result for the print request (S310, S326). As such, these notifications will not be printed again by the multifunction peripheral 4 regardless of whether acceptance of the print request has failed or execution of the printing has failed.

As described above, the email processing system 1 receives an email for causing a printer that has been registered in the email processing system 1 to print and causes the corresponding printer to execute printing on the basis of the received email, and also replies by email with the status of acceptance of the print request and the status of the print execution. However, in a case where the email received by the email processing system 1 is an email providing notification of the acceptance of the print request and of the print execution, in accordance with an email received earlier, then there will not again be a reply with an email providing notification of the status of acceptance and execution of printing. Also, even in a case where an email providing notification of the status of acceptance and print execution for a print request sent by the email processing system 1 is received by the email processing system 1 itself, then the received email is to be printed in a case where acceptance of the print request fails or execution of printing fails. As such, in a case where printing is not executed when an email is sent from the multifunction peripheral 5, which has been registered in the email processing system 1 as a printer, and an attempt is made to cause the remotely located multifunction peripheral 4 to print, then information on the acceptance failure of the print request or the failure of print execution is printed by the multifunction peripheral 5. For this reason, a user attempting to cause the multifunction peripheral 4 to print an image read by the multifunction peripheral 5 can know that printing is not executed at the multifunction peripheral 4, even though, for example, the multifunction peripheral 5 is not provided with a function for receiving an email or a function for reading a received email.

### 3. Other Embodiments

The technical scope of the invention is in no way limited to the embodiment described above; rather, it will be readily understood that a variety of modifications can be added in a scope that does not depart from the spirit of the invention. For example, the embodiment above illustrated an example where the multifunction peripheral 4 executed a print job automatically upon receiving the print queue information from the email processing system 1, but, for example, information indicative of the presence of a print job can be displayed on the user I/F 46 of the multifunction peripheral 4 having received the print queue information, the multifunction peripheral 4 then waiting for a user command to execute the print job before executing the print job. Also, in S42, the determination was carried out on the basis of the content of the body, but there is no limitation thereto; rather, the determination can be carried out on the basis of the title of the email, or, in a case where the transmission origin email address that is used is varied depending on the status being notified in S311 or S328, then the determination can be carried out on the basis of the transmission origin email address.

The embodiment above describes an example where the email processing system 1 is constituted of a plurality of physically independent server computers, but it would also be possible for the functions of the email processing system 1 to implemented with a single server computer.

The embodiment above described the multifunction peripherals 4, 5 as being provided with a function for sending an email, but the multifunction peripherals 4, 5 can also send to the email processing system 1 or to another server an email where the destination is an email address corresponding to a printer that is registered in the email processing system 1, by using XMPP or HTTP to communicate with the email processing system 1 or with the other server. The format of communication is also not limited to being the one described above, but rather another format of communication can be used. For example, instead of XMPP, another push-type communication such as Web Socket can be used.

In the embodiment above, a determination was made as to whether or not an email was from the email processing system itself, but the question of whether or not printing is necessary or notification of the status is necessary can be determined also for an email from another system. In such a case, the email processing system should store information on which position will be considered to make the determination for an email from a given system, as well as on what that position would be in the first state and what that position would be in the second state. The email processing system would then carry out the determination on the basis of this information. The system toward which the determination of whether or not it is necessary to print or whether or not notification of the status is necessary is directed must be alike for both whether or not it is necessary to print and for whether or not notification of the status is necessary.

What is claimed is:

1. An email processing system, comprising:
a communication unit for receiving an email sent to a pre-established address;
a determination unit for determining whether the received email is a first class of email for providing notification of a first state where some sort of action is needed regarding a predetermined data process with respect to a separate email or a second class of email for providing notification of a second state where no action is needed regarding the predetermined data process corresponding to the separate email; and
a processing unit for executing the predetermined data process based on an email determined to be the first class of email, but not executing the predetermined data process based on an email determined to be the second class of email.

2. The email processing system as set forth in claim 1, further comprising
a mail generation unit for generating either the first class of email or the second class of email, in accordance with the status of the predetermined data process, there being included identification information indicative of the status of the predetermined data process and a transmission destination being a transmission origin of the received email;
the communication unit sending the first class of email and the second class of email generated by the mail generation unit.

3. The email processing system as set forth in claim 2, wherein
the mail generation unit does not generate the first class of email and the second class of email in response to an email determined to be either the first class of email or the second class of email.

4. The email processing system as set forth in claim 1, wherein
the processing unit executes the predetermined data process based on an email determined not to be the first class of email and the second class of email.

5. The email processing system as set forth in claim 1, wherein
the first state includes failure of the predetermined data process, and the second state includes completion of the predetermined data process.

6. The email processing system as set forth in claim 1, wherein
the predetermined data process is a process for generating print data on the basis of the received email and sending the print data to a printer associated with the address.

7. An email processing method, comprising:
receiving an email sent to a pre-established address;
determining whether the received email is a first class of email for providing notification of a first state where some sort of action is needed regarding a predetermined data process with respect to a separate email or a second class of email for providing notification of a second state where no action is needed regarding the predetermined data process corresponding to the separate email; and
executing the predetermined data process based on an email determined to be the first class of email, but not executing the predetermined data process based on an email determined to be the second class of email.
